(19) United States
(12) Patent Application Publication
(10) Pub. No.: US 2024/0149495 A1
(43) Pub. Date: May 9, 2024

(54) Vacuum device

(71) Applicant: Producteers International GmbH, Schorndorf (DE)

(72) Inventor: Holger Krogsgaard, Schorndorf (DE)

(73) Assignee: Producteers International GmbH, Schorndorf (DE)

(21) Appl. No.: 18/500,242

(22) Filed: Nov. 2, 2023

(30) Foreign Application Priority Data
Nov. 4, 2022 (DE) 10 2022 004 179.0

(51) Int. Cl. B28D 7/02

(52) U.S. Cl. CPC B28D 7/02

(57) ABSTRACT

A vacuum device is used when working with a tool in masonry to vacuum dust that is produced. The device has at least one negative pressure chamber, at least one working space and a connection for a suction unit, of which the working space is delimited by a wall. In order to be able to reliably vacuum out the dust produced when working with different tools at any time using the vacuum device while having a simple design, the wall delimiting the working space has at least one wall section which can be adjusted into a position that opens the working space.

### BACKGROUND

Vacuum devices are known with which drill dust that is produced when drilling in masonry is vacuumed off at the drilling site so that it does not fall to the ground. The vacuum device is connected to a suction unit via a vacuum hose, with which the drill dust is vacuumed away from the drilling site. A negative pressure is created in the negative pressure chamber, which ensures that the vacuum device is pulled against the masonry.

Since the drill in a drilling tool does not change its position relative to the vacuum device during the drilling process, the drill dust can be vacuumed off very easily. However, tools are also known, such as slotting tools, with which slots are cut in masonry, for example. The drilling tool moves relative to the vacuum device, so that it is difficult to intercept and remove the material produced during slotting.

### SUMMARY

The disclosure is based on the object of designing a vacuum device in such a way that, with a simple design, dust that is generated when working with different tools can be reliably vacuumed off.

This object is achieved with a vacuum device for removing dust produced when working with a tool in masonry that includes a negative pressure chamber, a working space delimited by a wall, and a connection for a suction unit.

In the vacuum device, the wall delimiting the working space is provided with at least one wall section that can be adjusted into an open position. When working with a tool that has to be adjusted relative to the vacuum device during a construction process, the wall section can be pivoted into its open position so that the working space is opened. The material produced when working with such a tool can therefore be vacuumed out through the released opening via the connection by the suction unit.

If the tool is not moved relative to the vacuum device during the construction process, then the wall section remains in its closed position, so that the working space is circumferentially closed.

The wall section is advantageously mounted so that it can pivot about an axis. The wall section can so be easily adjusted from its closed position to its open position and vice versa. The articulation of the wall section has the further advantage that the wall section is always available and cannot be lost.

Arranging the adjustable wall section and the connection for the suction unit on opposite sides of a housing of the vacuum device contributes to a compact and simple design of the vacuum device.

In an advantageous embodiment, a transverse wall is arranged between the negative pressure chamber and the working space, with at least one opening being in the transverse wall that connects the working space to the connection. The material produced when working with the tool is vacuumed out through the opening by the suction unit into the connection, which is fluidly connected to the opening.

The transverse wall lies advantageously opposite the adjustable wall section in relation to the longitudinal direction of the housing.

A particularly advantageous design results when the vacuum device has two wall sections that can be adjusted in opposite directions. They can advantageously be adjusted into the open position independently of one another, so that either only one wall section or both wall sections can be adjusted into the open position. Since the wall sections can be adjusted in opposite directions to one another, there is a large inlet area for the material produced during construction, which can be reliably collected and vacuumed out by the large opening in the wall of the working chamber.

The two wall sections can advantageously be pivoted in opposite directions to one another about an axis each. This allows the two wall sections to each be adjusted into the open position in a targeted manner.

A particularly advantageous design results when the adjustable wall section is curved along its length. Such a design is particularly advantageous if the vacuum device is used on a vertical wall on which the tool works.

The material falling downwards in this case reaches the curved wall section, which, due to its curvature, guides the material towards the working space, where it can be safely vacuumed away.

The wall section is advantageously pivotally mounted with a side edge. As a result, the wall section can reveal a very large opening with a small pivoting path.

In the case in which the vacuum device is provided with the two wall sections, their end faces abut one another in their position closing the working space. Thereby the working space is perfectly closed in the area of the wall sections.

The working space and the negative pressure chamber are preferably open on the underside of the housing.

It is advantageous here if the side walls delimiting the working space and the negative pressure chamber are provided with sealing elements on the free edge. They ensure that the material accumulating in the working space does not escape to the outside and that the negative pressure can be generated in the negative pressure chamber, by which the vacuum device is pulled against the respective work surface.

The housing is preferably designed to be mirror-symmetrical to its longitudinal center plane.

In order to generate the negative pressure in the negative pressure chamber in a simple manner, the connection is advantageously connected to the negative pressure chamber via at least one opening. The air in the negative pressure chamber can therefore be vacuumed out through the opening of the connection, while the sealing elements ensure that no outside air can get into the negative pressure chamber from outside.

The subject matter of the application arises not only from the subject matter of the individual patent claims, but also from all the information and features disclosed in the drawings and the description. Even if they are not the subject of the claims, they are claimed to be essential to the invention if, individually or in combination, they are new compared to the prior art.

Further features of the invention result from the further claims, the description and the drawings.

The invention is explained in more detail based on an exemplary embodiment illustrated in the drawings.

### BRIEF DESCRIPTION OF THE DRAWINGS

FIG. 1 is a perspective view of a vacuum device with a connected suction hose.

FIG. 2 shows the vacuum device without a suction hose.

FIG. 3 is a perspective bottom view of the vacuum device.

FIG. 4 is a top view of the vacuum device.

FIG. 5 is a top view of the vacuum device in a second operating position.

FIG. 6 shows an enlarged view of a section along line A-A in FIG. 4 in a drilling application.

FIG. 7 shows a perspective view of the vacuum in a working position in a cutting application.

### DETAILED DESCRIPTION

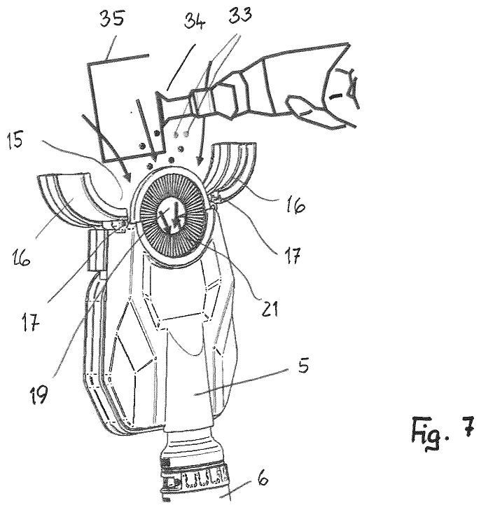

The vacuum device is used to vacuum up the waste generated when working with a tool directly at the work site. A drilling tool (FIG. 6) and a cutting tool (FIG. 7) are shown as examples of tools. However, the invention is not limited to these two different tools.

The vacuum device has a housing 1 which is open at the underside (FIG. 3). The housing 1 has an approximately trapezoidal shape in top view, i.e., it tapers from one end towards its other end.

The housing has a cover 2, on the edge of which a circumferential side wall 3 adjoins at an angle, preferably at a right angle.

At its wider end, the housing 1 is provided with a connecting pipe 5 for a suction hose 6, which is connected to a suction device (not shown) and with which the material produced during processing with the tool is vacuumed off in a manner to be described.

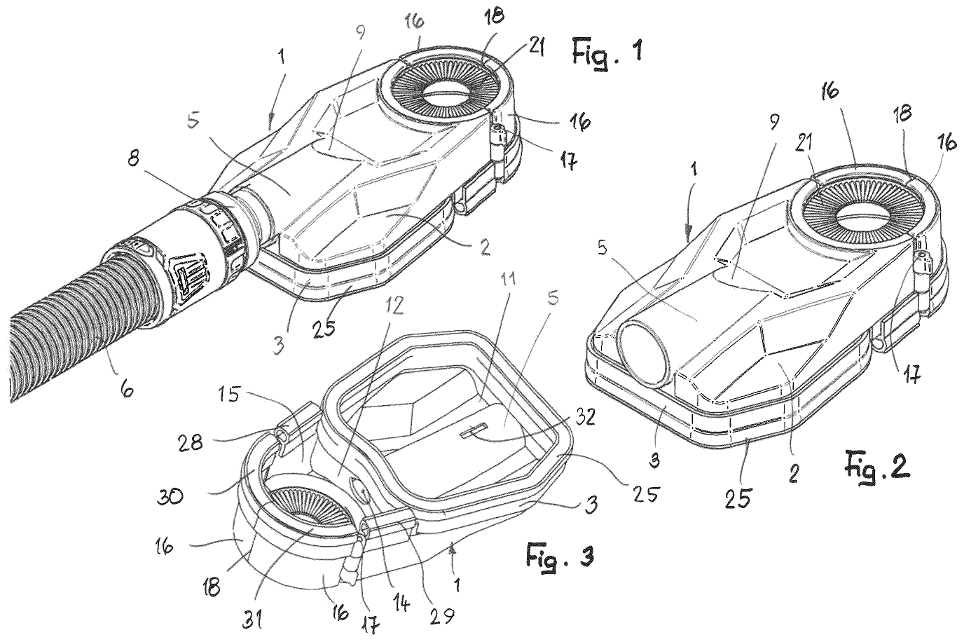

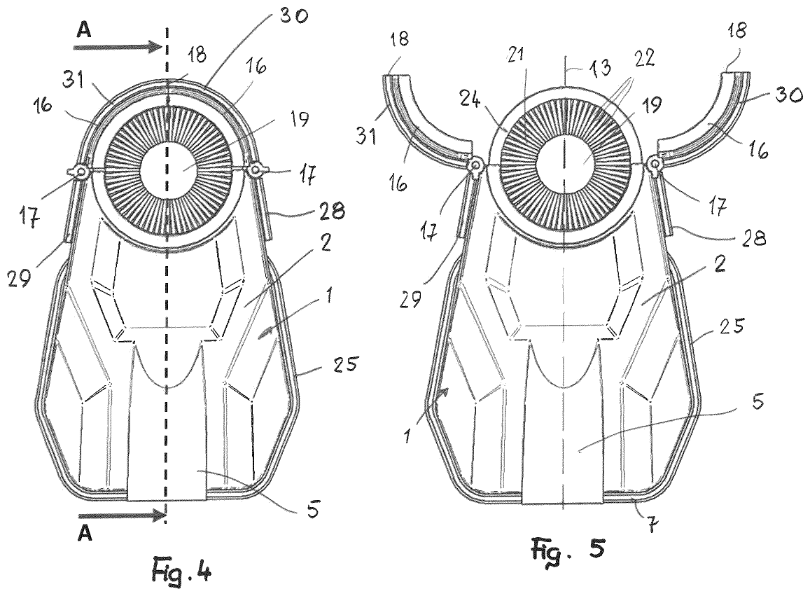

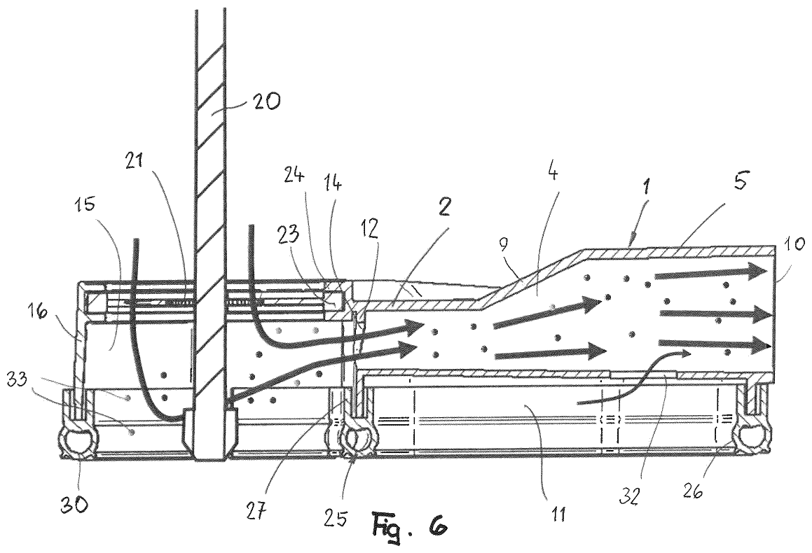

The connecting pipe 5, which is provided with a flow space 4 (FIG. 6), is advantageously formed in one piece with the cover 2 and is provided so that it is arranged at half the width of the housing 1 (FIGS. 4 and 5). The connecting pipe 5 is provided on the housing 1 in such a way that it does not protrude beyond its wider end face 7 (FIGS. 4 and 5). As can be seen from FIGS. 2 and 6, the upper part of the connecting pipe 5 is formed by a corresponding bulge in the cover 2 which is part circular in cross section. According to FIG. 2, the connecting pipe 5 has a circular internal cross section, at least in the connection area of the suction hose 6.

The suction hose 6 is inserted into the connecting pipe 5 with a corresponding cylindrical connecting part 8 and held or secured there in a suitable manner.

At a distance from the free end of the connecting pipe 5, the upper wall part is provided with a bevel 9 (FIGS. 1 and 2), which extends over the diameter of the connecting pipe 5.

The bevel 9 causes the flow cross section of the flow space 4 to increase in the direction of flow of the contaminated air (FIG. 6).

The flow space 4 has its smallest flow cross section in the entry area of the contaminated air. In the area of the bevel 9, the flow cross section increases steadily until it transitions into an area with a constant flow cross section. It extends to the insertion end 10 of the connecting pipe 5.

As FIG. 3 shows, the connecting pipe 5 projects downwards into a negative pressure chamber 11, which is bounded by a part of the side wall 3 of the housing 1 and a transverse wall 12, which extends transversely, preferably approximately perpendicular to the longitudinal plane of symmetry 13 (FIG. 5) of the housing 1 and connects opposing areas of the housing side wall 3 to one another.

The negative pressure chamber 11 is open to the underside of the housing 1.

The connecting pipe 5 connects to the transverse wall 12, with which it is advantageously designed in one piece. The transverse wall 12 for its part is also advantageously formed in one piece with the side wall 3 of the housing 1.

The transverse wall 12 extends from the cover 2, with which it is also advantageously formed in one piece. The free ends of the side wall 3 and the transverse wall 12 lie in a common plane.

The transverse wall 12 is provided with an opening 14 (FIGS. 3 and 6), through which the contaminated air to be extracted can flow into the connecting pipe 5. The cross section of the opening 14 is sufficiently large so that the material generated when working with the respective tool can be reliably vacuumed out.

The transverse wall 12 separates the negative pressure chamber 11 from a working space 15, which is provided at the narrower end of the housing 1 and which, like the negative pressure chamber 11, is open to the underside of the housing.

The working space 15 tapers towards the narrow end of the housing, at which the working space 15 is delimited by at least one adjustable wall section 16. In the exemplary embodiment, two wall sections 16 are provided, each of which can be pivoted about an axis 17 from a closed position according to FIG. 4 into an open position according to FIG. 5. The pivot axes 17 extend in the height direction of the housing 1.

In the closed position according to FIG. 4, the wall sections 16 adjoin one another with their end faces 18. In this closed position, the wall sections 16 can be held, for example, by magnetic forces with which the wall sections 16 are pressed firmly against one another with their end faces 18. Other engagement options can also be used, for example latches, clip connections and the like.

The two wall sections 16 are, for example, curved in the shape of a part of a partial circle and, in the closed position (FIG. 4), form a closed end section of the side wall 3 which extends approximately over 180°.

Both wall sections 16 are connected to the pivot axes 17 with their side edges facing one another.

Following the pivot axes 17, the opposing areas of the side wall 3 diverge until they merge into mutually converging side wall sections approximately at the level of the connecting pipe 5, which extend to the end face 7 of the housing 1, which are transverse, in the exemplary embodiment perpendicular to the longitudinal plane of symmetry 13 of the housing.

The described outline shape of the housing 1 is only to be understood as an example. Of course, the housing can also have any other suitable outline shape.

The two wall sections 16 close the working space 15 at the front in the closed position according to FIG. 4, so that this working space is delimited on the circumference by these wall sections 16 and the areas of the side wall 3 and the transverse wall 12 adjoining these wall sections.

In the cover area of the working space 15 there is a passage 19 through which a tool 20 can be inserted, which in the exemplary embodiment (FIG. 6) is a drill with which a hole can be made in a wall. The passage 19 is provided on an annular disk-shaped sealing part 21, which consists of individual tongues 22 which protrude radially inwards from an outer ring 23 (FIG. 6) and are elastically bendable. With their radially inner ends, the tongues 22 delimit the passage 19, the diameter of which is advantageously chosen so that the tongues are elastically bent when the tool 20 is pushed through and rest on the tool 20 with elastic deformation. The sealing part 21 prevents the drilling dust produced during drilling from escaping from the working space 15 to the outside.

The sealing part 21 or its outer ring 23 is accommodated in a retaining ring 24, which is advantageously formed in one piece with the cover 2 of the housing 1. The retaining ring 24 surrounds the outer ring 23 over the entire circumference.

The retaining ring 24 with the sealing part 21 forms the cover area of the working space 15.

The sealing part 21 can also have other designs. For example, it can be an elastically deformable disk with a central opening for the drill 20. The opening advantageously has a diameter that is smaller than the outer diameter of the drill shaft. Then the edge of the opening lies sealingly against the drill shaft with elastic deformation.

Sealing the drill shaft is not mandatory. If the suction flow generated by the suction device is sufficiently strong, the produced drill dust is reliably vacuumed away.

If the wall sections 16 are folded away into the open position (FIG. 5), the retaining ring 24 with the sealing part 21 projects over the pivot axes 17 approximately over half the diameter. The sealing part 21 is reliably held in the retaining ring 24 even in the open position of the housing 1. The two pivot axes 17 are diametrically opposed to one another in relation to the retaining ring 24.

A sealing ring 25 is placed on the free edge of the transverse wall 12 and the adjoining area of the side wall 3 (FIGS. 3 and 6), which has a sealing element 26 designed as a hollow body, which is elastically deformed in a manner to be described when the vacuum device is used, when the vacuum device is pressed against a wall or the like.

As follows from FIG. 6, the sealing ring 25, which is placed on the transverse wall 12 and on the adjacent free ends of the side wall areas including the end face 7, has a U-shaped profile part 27, between the legs of which are the free ends of the side wall 3 and the transverse wall 12 protrude. The sealing ring 25 can be attached to the side wall 3 and to the transverse wall 12 in a suitable manner. If the profile part 27 is designed accordingly, it is sufficient to attach the sealing ring 25 to the free edge of the side wall 3 and the transverse wall 12 in such a way that the legs of the U-shaped profile part 27 are elastically deformed and thereby ensure a secure fit of the sealing ring 25.

The hollow-shaped sealing element 26 ensures that a perfect seal is achieved even with an uneven contact surface.

The working space 15 is also largely sealed in the working position by sealing elements. FIG. 3 shows that a sealing element 28, 29 each is placed on the areas of the side wall 3 that are opposite one another and adjoining the transverse wall 12, which is designed in the same way as the sealing element 26 of the sealing ring 25. The two sealing elements 28, 29 are provided in the area between the transverse wall 12 and the pivot axis 17.

The pivotable wall sections 16 are also provided at their free ends with sealing elements 30, 31, which are designed in the same way as the sealing element 26 of the sealing ring 25. The sealing elements 30, 31 extend over the entire length of the free edge of the wall sections 16.

All sealing elements 26, 28 to 31 are at the same height (FIG. 6), so that the negative pressure chamber 11 and the working space 15 are securely sealed when the vacuum device is used.

The unsealed areas in the area of the pivot axes 17 are so small that they have no or only an insignificant influence on the suction effect.

The function of the vacuum device during a drilling process is explained with reference to FIG. 6.

The connecting part 8 of the suction hose 6 is inserted into the connecting pipe 5 and secured to the connecting pipe 5 in a suitable manner. The suction hose 6 is connected to a suction device (not shown) which generates the suction flow.

The vacuum device is attached, for example, to a wall in which the hole is to be made, with the sealing ring 25/the sealing elements 28 to 31. As soon as the suction device is switched on, a suction flow is generated.

The connecting pipe 5 is provided on its wall part located in the negative pressure chamber 11 with a flow opening 32 which, for example, has an elongated outline (FIG. 3). The air is vacuumed out of the negative pressure chamber 11 via the flow opening 32 and a negative pressure is thereby generated in the negative pressure chamber 11, which causes the vacuum device to be pulled against the wall. Since the sealing elements 26, 28 to 31 are designed as hollow profile parts and consist of an elastically flexible material, these sealing elements are correspondingly elastically deformed by the negative pressure generated in the negative pressure chamber 11, so that the negative pressure required to hold the vacuum device on the wall is sufficiently maintained as long as the suction device is switched on.

The drill 20 is inserted through the passage 19 of the sealing part 21, with the tongues 22 of the sealing part 21 abutting the drill 20 in a sealing manner. The drill 20 is used to drill the required hole in the wall. The drill dust 33 created during drilling is captured and vacuumed off by the suction flow. The suction flow generated by the suction device acts via the opening 14 in the transverse wall 12 in the working space 15, so that the drill dust 33 is captured and vacuumed off directly at the drilling site. The corresponding flow arrows are shown in FIG. 6, which show how the drill dust 33 passes with the suction flow via the opening 14 into the flow space 4 of the connecting pipe 5 and from there via the suction hose 6 to the suction device.

Since the sealing part 21 does not seal the working space 15 in an airtight manner, air is also vacuumed out of the surroundings of the vacuum device via the sealing part 21. In this way it is ensured that the drill dust 33 produced during drilling is completely captured and vacuumed off. The drill dust 33 so cannot settle on the masonry on which the hole is made. The outside air sucked in from the outside via the sealing part 21 reliably ensures that the drill dust 33 does not reach the outside via the sealing part 21, but is captured by the suction flow and fed to the suction device via the suction hose 6.

The suction flow that arises in the working space 15 also ensures that the drill dust 33 cannot escape from the housing 1 in the area of the pivot axes 17. The drill dust 33 is immediately captured by the suction flow within the working space 15 and fed to the connecting pipe 5 via the opening 14.

Since the vacuum device is pulled firmly against the masonry by the negative pressure prevailing in the negative pressure chamber 11, it can also be used to work on vertical walls. In this case too, the negative pressure prevailing in the negative pressure chamber 11 ensures that the vacuum device is pulled firmly against the masonry and does not have to be held by hand by the user of the drill 20. The user therefore has both hands free for the drilling process.

The two wall sections 16 lie close to one another with their end faces 18, so that the drill dust 33 cannot escape to the outside in this area.

FIG. 7 shows the option of using the vacuum device with tools that are moved relative to the vacuum device during the construction process.

A cutting tool 34 is shown, which is an example of a slotting tool with which a slot 35 is to be created in the masonry. The axis of rotation of the cutting tool 34 lies transversely to the pivot axes 17 of the wall sections 16, in contrast to the drilling tool with the drill 20, the axis of which lies parallel to the pivot axes 17.

In order for the material 33 produced when working with the cutting tool 34 to be captured by the vacuum device, the two wall sections 16 are pivoted outwards about the axes 17. In this working position (see also FIG. 5), the wall sections 16 extend upwards from the pivot axes 17 in the direction of the working area of the cutting tool 34. The two wall sections 16 thus form collection trays for the material 33, which is captured by the suction flow generated by the suction device and transported through the opening 14 in the transverse wall 12 into the connecting pipe 5 and from there via the connected suction hose 6 to the suction device. The suction power of the suction device is set so that the material 33 is reliably captured and vacuumed out.

Since the user knows where the slot 35 should be created on the masonry, the vacuum device is positioned so that the material 33 produced during the work process is produced in the suction area of the vacuum device.

The suction flow is adjusted so that the material 33 does not reach the outside through the passage 19 of the sealing part 21 into the environment, but is captured and vacuumed out by the suction flow.

It is particularly advantageous to use the vacuum device on a vertical wall. As a result of the described suction effect, the vacuum device is pressed firmly against the vertical wall, with the two wall sections 16 in the open position serving as collection trays through which the material 33 is reliably fed to the open working space 15, in which the material 33 is vacuumed off in the manner described.

Since the two wall sections 16 can be pivoted by approximately 90° from their closed position (FIG. 4) into the open position (FIG. 5), the wall sections 16 extend relatively far outwards in the open position, so that they have a large collecting area for the material 33 arising when working with the cutting tool 34. Since the wall sections 16 are curved, the material 33 that is not immediately captured by the suction flow, but instead reaches the wall sections 16, can slide there towards the open working space 15 and then be captured by the suction flow.

The open position of the wall sections 16 can be achieved by different measures. In the simplest case, the joint connection between the wall sections 16 and the housing 1 is designed such that the wall sections 16 come with a stop against a counter-stop, whereby the open position of the wall sections 16 is determined.

Another possibility is that the wall sections 16 are provided with latching elements which engage in latching elements on the housing side when the wall sections 16 have reached their open position. Such a latching connection has the advantage that the wall sections 16 cannot unintentionally pivot back towards their closed position.

The wall sections 16 can also be held in the open position by magnetic forces, for example, by providing corresponding magnets on the housing 1 or on the wall sections 16, which interact with corresponding magnetic parts of the respective other part.

The vacuum device is compact and therefore particularly suitable for DIY needs. In addition, the vacuum device is light in weight, making it easy to handle. The negative pressure chamber 11 can be designed to be relatively small and still enable a large holding force as a result of the negative pressure. As FIG. 3 shows, the negative pressure chamber 11 is larger than the working space 15. The described diverging and converging design of the opposing areas of the side wall 3 of the housing makes it possible for a sufficiently large negative pressure to be generated in the negative pressure chamber 11 despite the compact design of the housing 1.

The sealing ring 25 and the sealing elements 28 to 31 are advantageously detachably connected to the side wall 3 or the transverse wall 12, so that they can be easily replaced if necessary.

Vacuum cleaners can be used that can generate a sufficiently large negative pressure and a sufficiently large amount of air. A sufficiently large negative pressure is, for example, around 200 mbar. A sufficiently large air volume is around 25 l/s. These values are to be considered as examples only, not as limiting values.

1.-14. (canceled)

15. A vacuum device for removing dust produced when working with a tool in masonry, comprising:
a negative pressure chamber (11);
a working space (15) delimited by a wall (3, 12, 16); and
a connection (5) for a suction unit,
wherein the wall (3, 12, 16) delimiting the working space (15) includes an adjustable wall section (16) which can be adjusted into a position opening the working space (15).

16. The vacuum device according to claim 15,
wherein the adjustable wall section (16) is pivotally mounted about an axis (17).

17. The vacuum device according to claim 15,
wherein the adjustable wall section (16) and the connection (5) for the suction unit are arranged on opposite sides of a housing (1) of the vacuum device.

18. The vacuum device according to claim 17,
wherein a transverse wall (12) is arranged between the negative pressure chamber (11) and the working space (15), and
wherein the transverse wall (12) comprises at least one opening (14) which connects the working space (15) to the connection (5) through the transverse wall (12).

19. The vacuum device according to claim 18,
wherein the adjustable wall section (16) lies opposite the transverse wall (12) relative to a longitudinal extension of the housing (1).

20. The vacuum device according to claim 15,
wherein the wall (3, 12, 16) delimiting the working space (15) has two wall sections (16) which can be adjusted in opposite directions.

21. The vacuum device according to claim 20,
wherein the two wall sections (16) can each be pivoted in opposite directions to one another about a respective axis (17).

22. The vacuum device according to claim 15,
wherein the adjustable wall section (16) is curved along its length.

23. The vacuum device according to claim 15,
wherein the adjustable wall section (16) is pivotally mounted with a side edge.

24. The vacuum device according to one of claim 20,
wherein the two wall sections (16) abut one another with their end faces (18) in their position closing the working space (15).

25. The vacuum device according to claim 17,
wherein the working space (15) and the negative pressure chamber (11) are open on an underside of the housing (1).

26. The vacuum device according to claim 15,
wherein side walls (3, 12, 16) delimiting the working space (15) and the negative pressure chamber (11) are provided with sealing elements (26, 28 to 31) on a free edge.

27. The vacuum device according to claim 17,
wherein the housing (1) is designed to be mirror-symmetrical to its longitudinal center plane (13).

28. The vacuum device according to claim 15,
wherein the connection (5) is connected to the negative pressure chamber (11) via at least one opening (32).
